(19) United States
(12) Patent Application Publication
(10) Pub. No.: US 2025/0329935 A1
(43) Pub. Date: Oct. 23, 2025

(54) WAVEGUIDE TRANSITION FOR SINGLE LAYERED WAVEGUIDE ANTENNAS

(71) Applicant: Aptiv Technologies AG, Schaffhausen (CH)

(72) Inventors: Qinjiang RAO, Oak Park, CA (US); Shawn SHI, Newbury Park, CA (US)

(73) Assignee: Aptiv Technologies AG, Schaffhausen (CH)

(21) Appl. No.: 18/640,586

(22) Filed: Apr. 19, 2024

(51) Int. Cl. H01Q 13/22; H01Q 13/28

(52) U.S. Cl. CPC H01Q 13/22; H01Q 13/28

(57) ABSTRACT

A radar control module includes a printed circuit board including a radio frequency port. A trough waveguide antenna is mounted to the printed circuit board and includes a base and a pair of sidewalls extending from the base and an open side opposite the base. A transition path extends vertically relative to the printed circuit board and extends from the radio frequency port and in communication with an end of the trough waveguide antenna.

### FIELD

The present disclosure relates to a waveguide transition for single layered waveguide antennas.

### BACKGROUND

This section provides background information related to the present disclosure which is not necessarily prior art.

A side opened rectangular waveguide antenna called asymmetrical trough waveguide antennas have been proposed for use since the 1950s. The asymmetrical trough waveguide antenna provides for economical fabrication with a single layered structure and mechanical simplicity. One of the challenges is providing a transition for single layered waveguide antennas with low sidelobes.

### SUMMARY

This section provides a general summary of the disclosure, and is not a comprehensive disclosure of its full scope or all of its features.

According to an aspect of the present disclosure, a radar control module includes a printed circuit board including a radio frequency port. A trough waveguide antenna is mounted to the printed circuit board and includes a base and a pair of sidewalls extending from the base and an open side opposite the base. A transition path extends vertically relative to the printed circuit board and extends from the radio frequency port and in communication with an end of the trough waveguide antenna.

According to a further aspect, the trough waveguide antenna includes a center fin extending from the base.

According to a further aspect, the center fin is parallel to the pair of sidewalls.

According to a further aspect, the transition path includes a sidewall structure that transitions a vertical path into a curved path that directs the transition path horizontally relative to the printed circuit board and into the end of the trough waveguide antenna.

According to a further aspect, the sidewall structure includes a radiused roof.

According to a further aspect, the sidewall structure includes a first wall extending vertically downward from an end of the base.

According to a further aspect, the sidewall structure includes a second wall parallel to and spaced from the first wall and third and fourth walls extending between opposite respective edges of the first and second walls, wherein the radiused roof extends from an upper end of the second wall toward the end of the trough waveguide antenna.

According to a further aspect, the third and fourth walls are aligned with the pair of sidewalls of the trough waveguide antenna.

According to a further aspect, the transition path has a width equal to a width between the pair of sidewalls.

According to a further aspect, the printed circuit board includes a monolithic microwave integrated circuit (MMIC) for providing radio frequency signals to the radio frequency port.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic top view of a radar control module board according to the principles of the present disclosure;

FIG. 2 is a schematic side view of the radar control module board according to the principles of the present disclosure;

FIG. 3 is a side view of a trough waveguide antenna having a transition structure according to the principles of the present disclosure;

FIG. 4 is a cross-sectional view of the trough waveguide antenna having a transition structure according to the principles of the present disclosure;

FIG. 5 is a perspective view of the space within the trough waveguide antenna having a transition pathway according to the principles of the present disclosure;

FIG. 6 is a detailed perspective view of the space within the transition pathway of the trough waveguide antenna according to the principles of the present disclosure; and

FIG. 7 is a perspective view of a known trough waveguide antenna according to the principles of the present disclosure.

Corresponding reference numerals indicate corresponding parts throughout the several views of the drawings.

### DETAILED DESCRIPTION

Example embodiments will now be described more fully with reference to the accompanying drawings.

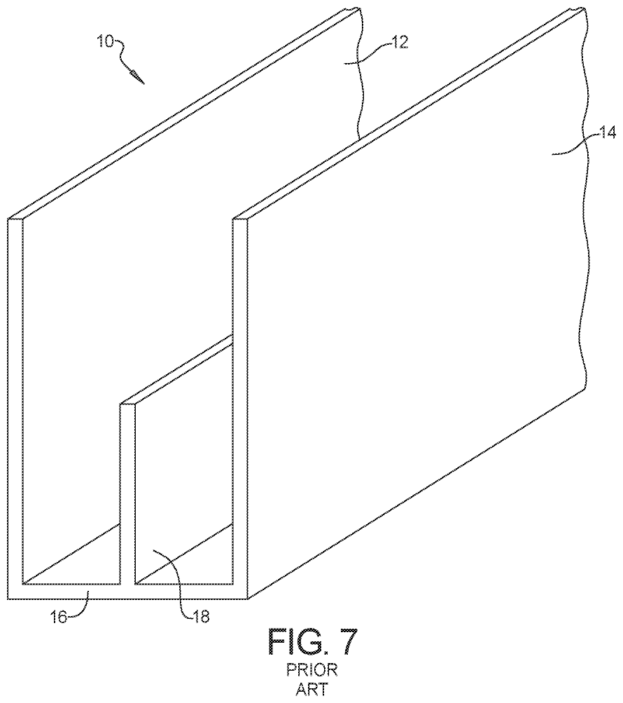

With reference to FIG. 7, a known trough waveguide antenna 10 is shown as disclosed in U.S. Pat. No. 3,015,100. The trough waveguide antenna includes a pair of sidewalls 12, 14, a bottom wall 16 and a substantially centrally disposed fin member 18. When the side walls 12, 14 are less than one half wavelength apart, a transverse electric mode may be propagated along the axis of the guide. This mode is “bound” to the center fin and has an electric field with a general configuration as shown in FIG. 7. The intensity of the filed lines of the electric vector increases from the bottom 16 of the waveguide to the top of the central vane or fin 18. The transverse currents on the sides of fin 18 vary from a minimum at the free edge to a maximum at its base.

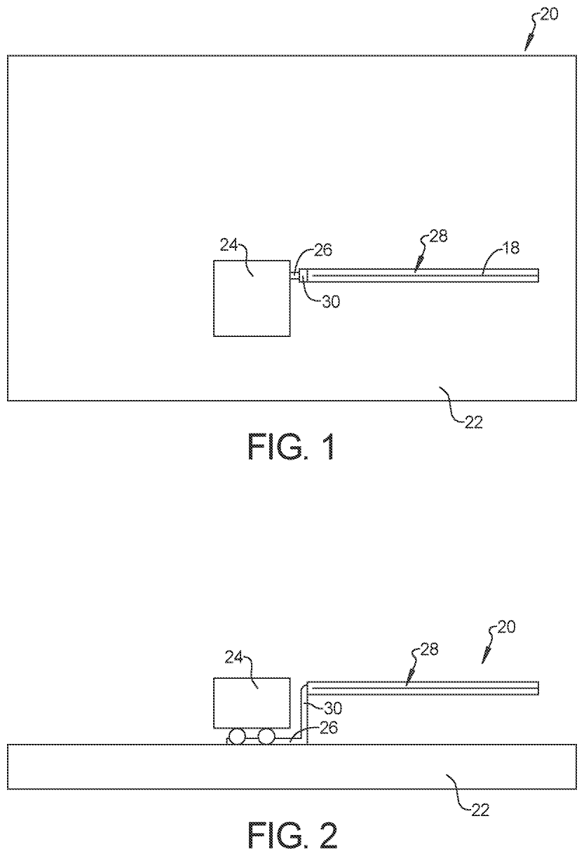

With reference to FIGS. 1 and 2, a radar control module board 20 is shown including a printed circuit board 22. A monolithic microwave integrated circuit (MMIC) 24 is mounted to the printed circuit board 22. The MMIC 24 provides a radio frequency port 26. A trough waveguide antenna 28 is mounted to the printed circuit board 22. A transition structure 30 is mounted to an end of the trough waveguide antenna 28. The transition structure 30 defines a transition pathway 32 (see FIGS. 4-6) for the radio frequency signal from the radio frequency port 26 of the MMIC 24.

The trough waveguide antenna 28 is similar to the trough waveguide antenna 10 disclosed in U.S. Pat. No. 3,015,100 and can be modified in known ways to include asymmetries 34 within the trough and other variations. In particular, the trough waveguide antenna 28 includes a pair of sidewalls 12, 14, a bottom wall 16 and a substantially centrally disposed fin member 18. The trough waveguide antenna 28 has an open side opposite the bottom wall and include open ends.

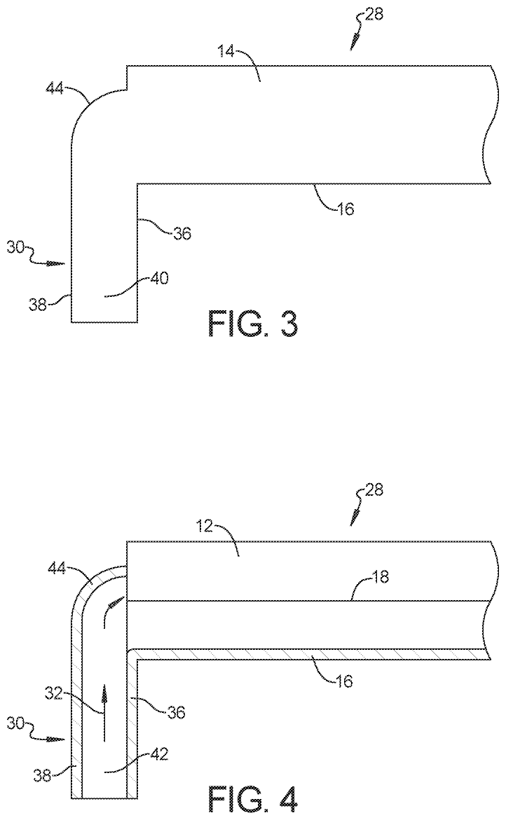

With reference to FIGS. 3 and 4, the transition structure 30 includes a first wall 36 extending vertically downward from an end of the base 16, a second wall 38 parallel to and spaced from the first wall 36 and a pair of third and fourth walls 40, 42 extending between opposite respective edges of the first and second walls 36, 38. A radiused roof structure 44 extends from the second wall 38 to the end of the trough waveguide antenna 28.

The transition structure 30 defines the transition pathway 32 vertically from the radio frequency port 26 of the MMIC 24 and the radiused roof structure 44 transitions the radio frequency signal horizontally relative to the printed circuit board 22 and into an end of the trough waveguide antenna 28.

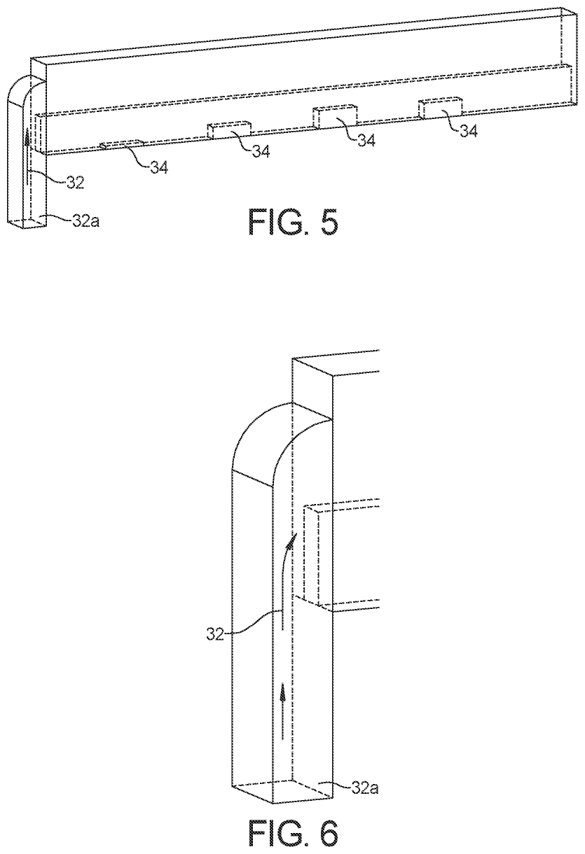

FIGS. 5 and 6 provide a 3-dimensional illustration of the space within the trough waveguide antenna 28 and the transition pathway 32 within the transition structure 30. A lower end 32a of the transition pathway 32 is in communication with the radio frequency port 26 of the MMIC, as shown in FIG. 2. The transition pathway 32 may have a width equal to a width between the pair of sidewalls 12, 14 of the trough waveguide antenna. Accordingly, the third and fourth walls 40, 42 are spaced at a width equal to the width of the pair of sidewalls 12, 14. Further, the transition pathway 32 opens into the end of the trough waveguide antenna at a height of between 60-90 percent of a height of the pair of sidewalls 12, 14 and more particularly between 70-80 percent of a height of the pair of sidewalls 12, 14. In particular, the radiused roof structure 44 transitions the pathway horizontally relative to the printed circuit board 22 and into the end of the trough waveguide antenna 28.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A radar control module, comprising:
a printed circuit board including a radio frequency port;
a trough waveguide antenna mounted to the printed circuit board and having a base and a pair of sidewalls extending from the base and an open side opposite the base; and
a transition path extending vertically relative to the printed circuit board and extending from the radio frequency port and in communication with an end of the trough waveguide antenna.

2. The radar control module according to claim 1, wherein the trough waveguide antenna includes a center fin extending from the base.

3. The radar control module according to claim 2, wherein the center fin is parallel to the pair of sidewalls.

4. The radar control module according to claim 1, wherein the transition path includes a sidewall structure that transitions a vertical path into a curved path that directs the transition path horizontally relative to the printed circuit board and into the end of the trough waveguide antenna.

5. The radar control module according to claim 4, wherein the sidewall structure includes a radiused roof.

6. The radar control module according to claim 5, wherein the sidewall structure includes a first wall extending vertically downward from an end of the base.

7. The radar control module according to claim 6, wherein the sidewall structure includes a second wall parallel to and spaced from the first wall and third and fourth walls extending between opposite respective edges of the first and second walls, wherein the radiused roof extends from an upper end of the second wall toward the end of the trough waveguide antenna.

8. The radar control module according to claim 1, wherein the third and fourth walls are aligned with the pair of sidewalls of the trough waveguide antenna.

9. The radar control module according to claim 1, wherein the transition path has a width equal to a width between the pair of sidewalls.

10. The radar control module according to claim 1, wherein the printed circuit board includes a monolithic microwave integrated circuit (MMIC) for providing radio frequency signals to the radio frequency port.

11. A radar control module, comprising:
a printed circuit board including a radio frequency port;
a trough waveguide antenna mounted to the printed circuit board and having a base and a pair of sidewalls extending from the base and an open side opposite the base; and
a transition structure extending from an end of the trough waveguide antenna and in communication with the radio frequency port.

12. The radar control module according to claim 11, wherein the printed circuit board includes a monolithic microwave integrated circuit (MMIC) for providing radio frequency signals to the radio frequency port.

13. The radar control module according to claim 11, wherein the trough waveguide antenna includes a center fin extending from the base.

14. The radar control module according to claim 13, wherein the center fin is parallel to the pair of sidewalls.

15. The radar control module according to claim 11, wherein the transition structure includes a first wall extending vertically downward from an end of the base.

16. The radar control module according to claim 15, wherein the transition structure includes a second wall parallel to and spaced from the first wall and third and fourth walls extending between opposite respective edges of the first and second walls.

17. The radar control module according to claim 16, wherein the transition structure includes a radiused roof that extends from an upper end of the second wall toward the end of the trough waveguide antenna.

18. The radar control module according to claim 11, wherein the third and fourth walls are aligned with the pair of sidewalls of the trough waveguide antenna.
